(19) United States
(12) Patent Application Publication
(10) Pub. No.: US 2007/0032254 A1
(43) Pub. Date: Feb. 8, 2007

(54) System and method for providing efficient spectrum usage of wireless devices in unlicensed bands

(75) Inventor: Shiuh Yuan Chen, Sunnyvale, CA (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(73) Assignee: Hitachi, Ltd.

(21) Appl. No.: 11/196,548

(22) Filed: Aug. 2, 2005

(51) Int. Cl. H04Q 7/20; H04B 7/00

(52) U.S. Cl. 455/509

(57) ABSTRACT

A system for managing spectrum usage of co-operating wireless devices. The system comprises a plurality of co-operating wireless devices, each co-operating wireless device capable of sensing spectrum usage where the co-operating wireless device operates and of generating spectrum usage information; and a spectrum access controller communicatively coupled to each of the co-operating wireless devices, the spectrum access controller capable of receiving the spectrum usage information from each of the co-operating wireless devices and for managing spectrum allocation to the co-operating wireless devices based on the spectrum usage information.

### BACKGROUND

1. Technical Field

This invention relates generally to wireless devices, and more particularly provides a system and method for providing efficient spectrum usage of wireless devices, e.g., in unlicensed bands.

2. Description of the Background Art

Widespread use of wireless devices by consumers has led to inefficient use of spectrum resources in the unlicensed bands as each device contends for spectrum use in an uncoordinated manner. Often times, such contention of wireless device usage results unknowingly in overlapping spectrums. When the frequency bands of multiple devices overlap, communication performance of these wireless devices degrades. The current generation of unlicensed wireless devices does not possess sufficient flexibility or intelligence to minimize interference with other unlicensed users. Such conventional wireless devices are designed only to coexist with similar kinds of devices. As high data rate media-centric devices, which consume larger bandwidth, become ubiquitous in the next few years, this problem will be further aggravated.

Accordingly, systems and methods that provide more efficient spectrum usage of wireless devices, e.g., in the unlicensed bands, are needed.

### SUMMARY

Embodiments of the invention attempt to alleviate the problem of inefficient use of spectrum resources, e.g., in unlicensed bands, by overlaying a wireless infrastructure to facilitate coordinated spectrum sharing among the unlicensed wireless devices. One embodiment entails the use of a spectrum access controller within a locality (e.g. home, wireless hotspot etc.) that coordinates spectrum usage of unlicensed wireless devices operating in its locality. The spectrum access controller includes a coordination function that uses a database to track and manage spectrum usage of these wireless devices.

In a first embodiment, the present invention provides a system comprising: a plurality of co-operating wireless devices, each co-operating wireless device capable of sensing spectrum usage where the co-operating wireless device operates and of generating spectrum usage information; and a spectrum access controller communicatively coupled to each of the co-operating wireless devices, the spectrum access controller capable of receiving the spectrum usage information from each of the co-operating wireless devices arid for managing spectrum allocation of the co-operating wireless devices based on the spectrum usage information.

The spectrum access controller may be coupled to at least one co-operating wireless device using a multi-hop protocol. The access controller may request at least two co-operating wireless devices to operate using the same channel. The system may also include a legacy wireless device operating near at least one co-operating wireless device, wherein the co-operating wireless device senses the spectrum usage of the legacy wireless device, and wherein the spectrum usage information identifies the spectrum use of the legacy wireless device. Each co-operating wireless device may conduct spectrum sensing at a regular interval. Each co-operating wireless device may be capable of receiving parameters from the access controller, the parameters defining a spectrum channel over which to communicate when performing the function of the co-operating wireless device. Each co-operating wireless device may be configured to send device information to the access controller, the device information for use by the access controller to manage spectrum allocation.

In another embodiment, the invention provides a method of controlling spectrum usage of wireless device, the method comprising: sensing spectrum usage where a wireless device operates; generating spectrum usage information based on the sensing; transmitting the spectrum usage information to an access controller; awaiting from the access controller spectrum allocation parameters based on the spectrum usage information; and configuring a transceiver in the wireless device based on the spectrum allocation parameters from the access controller.

The step of sensing may include sensing interference by a legacy device operating near the wireless device, and wherein the spectrum usage information identifies the spectrum use of the legacy device. The wireless device may conduct spectrum sensing at a regular interval. The method may also include sending device information by the wireless device to the access controller, the device information for use by the access controller to manage spectrum allocation.

In another embodiment, the present invention provides a method of managing spectrum usage of a wireless device, comprising: receiving spectrum usage information specifying spectrum usage where wireless devices operate; generating spectrum allocation parameters for each of the wireless devices based on the spectrum usage information; and sending spectrum allocation parameters to the wireless devices.

The step of generating spectrum allocation parameters may include generating spectrum allocation parameters for configuring at least two co-operating wireless devices to operate using the same channel. The spectrum allocation parameters may account for the spectrum use of legacy wireless devices. The method may occur at a regular interval. The method may further include receiving device information from the wireless device, the device information for use by the access controller in the step of generating spectrum allocation parameters.

### BRIEF DESCRIPTION OF THE DRAWINGS

FIG. 1 is a block diagram illustrating a computer network in accordance with an embodiment of the present invention;

FIG. 2 is a block diagram illustrating details of an access controller, in accordance with an embodiment of the present invention;

FIG. 3 is a block diagram illustrating details of a co-operating wireless device, in accordance with an embodiment of the present invention;

FIG. 4 is a flow diagram illustrating a method of installing the access controller at a new locality, in accordance with an embodiment of the present invention;

FIG. 5 is a flow diagram illustrating a method of installing a co-operating wireless device at a new locality, in accordance with an embodiment of the present invention;

FIG. 6 is a flow diagram illustrating a method of normal operation of co-operating wireless devices and the access controller, in accordance with an embodiment of the present invention;

FIG. 7 is a flow diagram illustrating a method of handling legacy wireless devices in the network, in accordance with an embodiment of the present invention; and

FIG. 8 is a block diagram illustrating details of an example computer system.

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

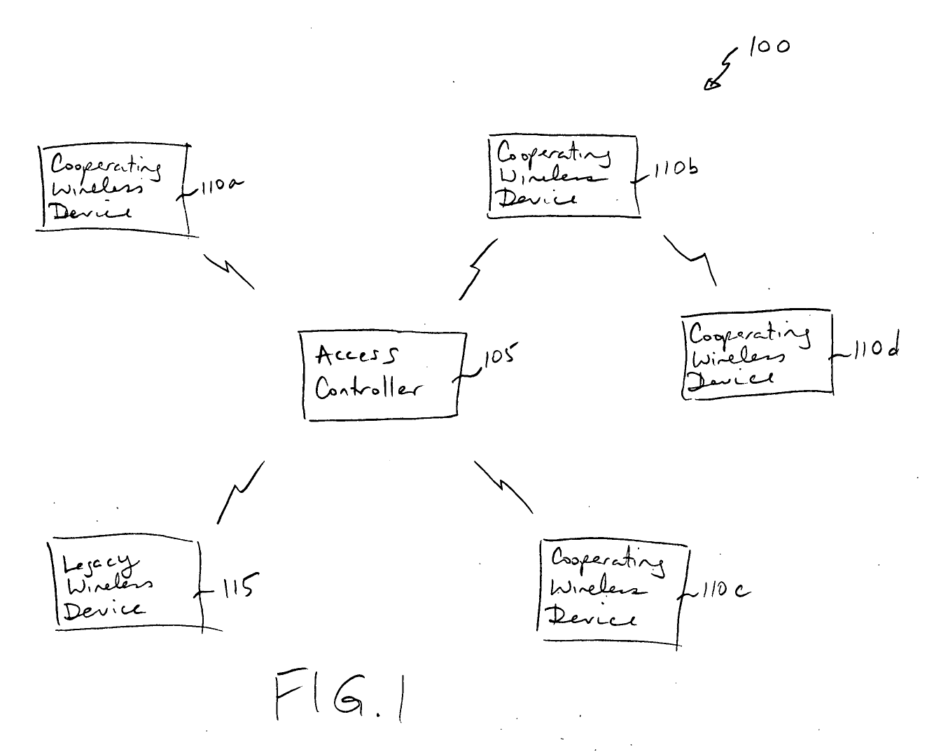

FIG. 1 illustrates an example network architecture 100 in accordance with an embodiment of the present invention. Network architecture 100 includes a plurality of co-operating wireless devices 110a-d (any device 110a-d referred to generally as device(s) 10), each wirelessly coupled, directly or indirectly, to an access controller 105. Specifically, co-operating wireless devices 110a-c are wirelessly coupled directly to access controller 105. Co-operating wireless device 110d is wirelessly coupled indirectly to access controller 105, in this case, via co-operating wireless device 110b using a multi-hop protocol. Network architecture 100 also include a legacy wireless device 115, operating within the locality managed by the access controller 105 and/or near any or all of the co-operating wireless devices 110. Collectively, the co-operating wireless devices 110 form a multi-hop network 100 to forward frames via uplink to the access controller 105 and downlink to other co-operating wireless devices 110. This multi-hop network configuration effectively extends the coverage of the access controller 105.

Generally, a co-operating wireless device 110 is a wireless device configured to communicate with the access controller 105 and other co-operating wireless devices 110 via an auxiliary control channel (e.g., a dedicated channel) within a locality so that the co-operating wireless device 110 can cooperate, thereby ensuring spectrum-organized coexistence. In one embodiment, the co-operating wireless device 110 may be a co-operating unlicensed device. Example wireless devices 110 include WLAN access points and stations, Bluetooth devices and cordless phones. Generally, a co-operating wireless device 110 encapsulates a legacy wireless device with a spectrum sensing mechanism capable of sensing the RF signals where the co-operating wireless device 110 operates. The co-operating wireless device 110 within a locality includes a distributed sensing mechanism for the spectrum access controller 105, wherein every co-operating wireless device 110 in a locality transmits its spectrum sensing information back to the spectrum access controller 105. Distributing the sensing mechanisms at the wireless devices 110 may prove to be more robust than a centralized sensing mechanism at the access controller 105. Centralized control at the access controller 105 offloads the decision making burden from the co-operating wireless device 110, thereby reducing the hardware complexity and cost of the co-operating wireless device 110. Accordingly, embodiments may use centralized intelligence with distributed sensing to optimize the spectrum allocation and usage, hence alleviating the random nature of unlicensed band usage. However, in other embodiments, centralized RF sensing and/or distributed control can be used.

In contrast with a co-operating wireless device 110, a legacy wireless device 115 is an unlicensed wireless device that is incapable of cooperating with the access controller 110 or other co-operating wireless devices 110. Since spectrum use of legacy wireless devices 115 cannot be managed, the access controller 105 attempts to manage nearby co-operating wireless devices 110 to tolerate or “work around” these legacy devices 115.

Each co-operating wireless device 110 senses spectrum use in its environment. For example, co-operating wireless devices 110a and 110c may sense the RF spectrum use of the legacy wireless device 115. However, for example, due to distance, co-operating wireless devices 110b and 110d may not sense the RF spectrum use of the legacy wireless device 115. Each co-operating wireless device 110 sends spectrum usage information to the access controller 105. The access controller 105 uses this spectrum usage information to coordinate spectrum use among the co-operating wireless devices 110 efficiently. For example, co-operating wireless devices 110a and 110c may be configured to use dedicated portions of the RF spectrum that will not affect the performance of or have its performance affected by legacy wireless device 115. Further, one or both co-operating wireless devices 110b and 110d may use the same RF spectrum as legacy wireless device 115, since they are outside the RF environment used by legacy wireless device 115. The determination whether both co-operating wireless devices 110b and 110d can use the same RF spectrum will depend on whether either's RF use can be sensed by the other. Further, the access controller 105 will account for RF use of neighboring co-operating wireless devices 110. For example, cooperating wireless device 110a may be able to use the same RF spectrum as co-operating wireless device 110d.

In one embodiment, the access controller 105 acts as the centralized intelligence that makes decisions pertaining to spectrum usage planning. In this embodiment, one of its tasks is to manage and coordinate spectrum resource usage of the co-operating wireless devices 110 within-its locality. A “locality” may refer to the geography where the co-operating wireless devices 110 under the control of the access controller 105 operate. Because of the multi-hop capability that connects the co-operating wireless devices 110 to the access controller 105, a locality can effectively have a maximum coverage range between the access controller 105 and the edge of the multi-hop network 100.

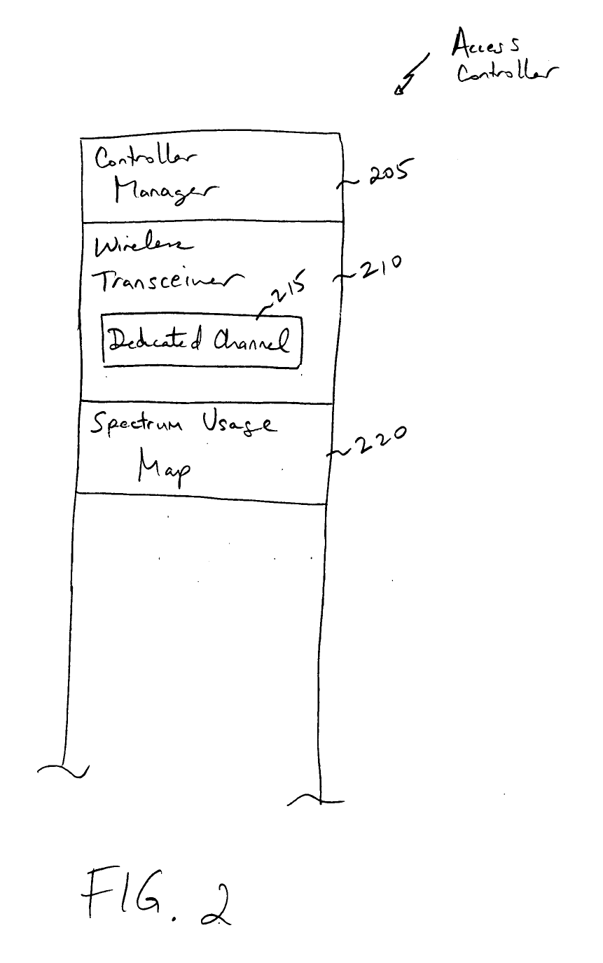

FIG. 2 is a block diagram illustrating details of the access controller 105, in accordance with an embodiment of the present invention. The access controller 105 includes a controller manager 205, a wireless transceiver 210 that may be set to communicate with co-operating wireless devices 110 over a dedicated channel 215, and spectrum usage map 220.

In one embodiment, the controller manager 205 is a software algorithm that manages the operations of the access controller 105. For example, the controller manager 205 may control the incoming and outgoing of co-operating wireless devices 110, being moved to new localities, and normal operations. All types of operations generally include receiving spectrum sensing information from the co-operating wireless devices 110 in the locality, generating spectrum allocation parameters for the co-operating wireless devices 110 based on the spectrum usage information, and sending spectrum allocation parameters to the co-operating wireless devices 110.

The controller manager 205 manages the spectrum usage map 220. The spectrum usage map 220 is a database that maintains the information related to the co-operating wireless devices 110 in the locality. The transceiver parameters for each co-operating wireless device 110 such as device type (WLAN, Bluetooth, cordless phone, etc.) carrier frequency, bandwidth, transmit power and modulation scheme may be stored in the spectrum usage map 220. These parameters are used to determine the optimal spectrum resource allocation for the co-operating wireless devices 110. The access controller 105 is capable of supporting virtually any unlicensed band. As new unlicensed bands become allocated by regulatory bodies, the spectrum usage map 220 can be updated with the operating rules to support the new bands.

The wireless transceiver 210 operates at a predetermined dedicated channel 215, such that all co-operating wireless devices 110 know to communicate at that channel. That way, a new co-operating wireless device 110 and/or a new access controller 105 can communicate. It will be appreciated that the wireless transceiver 210 could be capable of multiple dedicated channels 215, such that the co-operating wireless devices 110 know to attempt communication across all dedicated channels until a connection is made. That way, if any RF interference affects the quality of any of the channels 210, a different channel 210 is available. The dedicated channel is preferably reliable and robust. A low data rate bandwidth may be sufficient. An ad-hoc multi-hop network may form the backbone communication of the channel. It may use a simple communication protocol for low transceiver complexity.

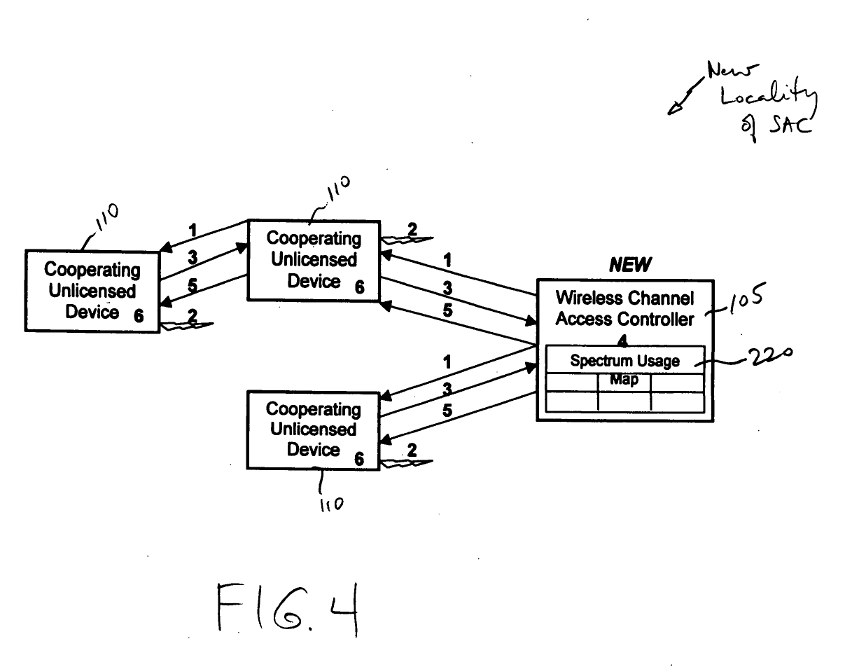

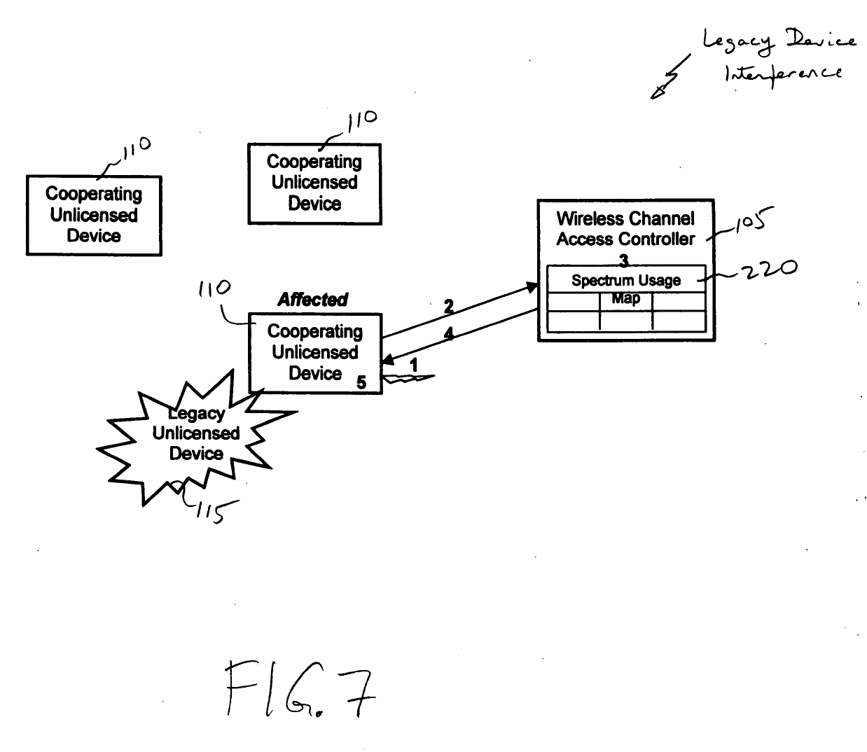

The methods performed by the access controller 105 (1) when being moved to another locality, (2) when recognizing incoming or outgoing co-operating devices, and (3) during normal operations are described in detail with reference to FIGS. 4-7.

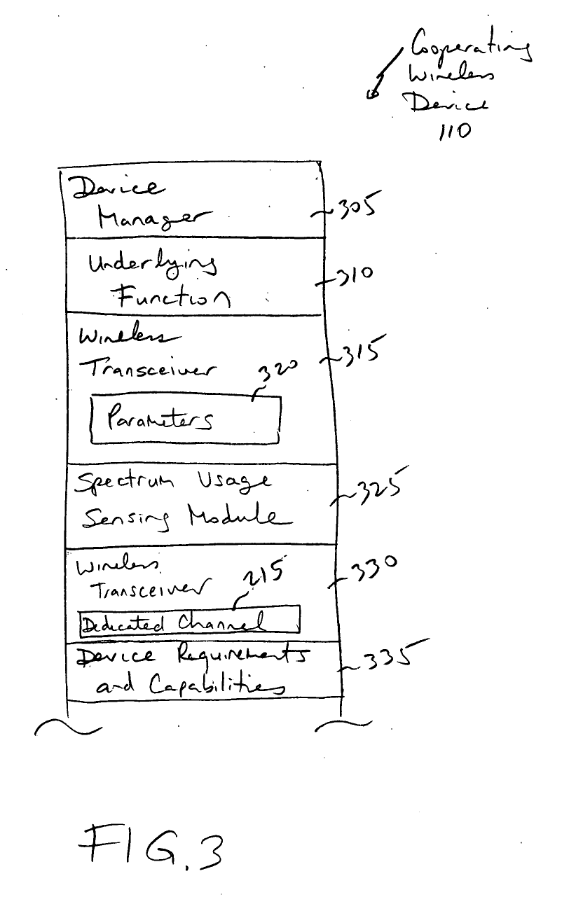

FIG. 3 illustrates details of a co-operating wireless device 110 in accordance with an embodiment of the present invention. Co-operating wireless device 110 includes a device manager 305, an underlying function 310 (e.g., telephone capabilities, multimedia capabilities, Bluetooth capabilities, etc.), a first wireless transceiver 315 that communicates over a particular channel in accordance with configurable/selectable/settable parameters 320, a spectrum usage sensing module 325, a second wireless transceiver 330 that communicates over the dedicated channel 215 (or channels 215), and device requirements and capabilities 335.

In one embodiment, the device manager 305 is a software algorithm that manages operations of the co-operating wireless device 305. For example, the device manager 305 may control initialization when moving localities, periodic sensing of RF interference, and communications with the access controller 105.

The spectrum sensing usage module 325 is capable of sensing RF interference from neighboring legacy devices 115, from other co-operating wireless devices 110, and from other devices causing interference. The device manager 315 may instruct the spectrum usage sensing module 325 when to conduct its sensing events, or the spectrum usage sensing module 325 may be configured to automatically sense spectrum at periodic intervals or in response to other criteria, e.g., a particular times, continuously, after particular events, etc. The device manager 305 may instruct the wireless transceiver 330 to send the spectrum usage information to the access controller 105 over the dedicated channel 215.

The device manager 305 will also send the device requirements and capabilities 335 to the access controller 105. Device requirements and capabilities may include device transceiver operating parameters such as needed bandwidth, available channels, data rate, etc. The access controller 105 will use the device requirements and capabilities information 335 to manage spectrum use. It will be appreciated that device requirement and capabilities need only be sent once to the access controller 105, e.g., when the co-operating wireless device 110 is being moved to a new locality, when the access controller 105 is moved to the locality of the wireless device 110, etc. However, the device requirements and capabilities may be sent more often, e.g., with every transmission.

It will be appreciated that the co-operating wireless device 110 in this embodiment includes two transceivers 315 and 330, so that the first transceiver 315 can effect the underlying function 310 at the channel set by the parameters 320 received from the access controller 105, while the second transceiver 330 can effect communication with the access controller 105 over the dedicated channel 215. In other embodiments, the co-operating wireless device 110 may include only one transceiver for both purposes.

The operation of the network 100 is explained for the following scenarios:

New Locality of Access Controller 105

As shown in FIG. 4, when an access controller 105 comes online at a new locality:
1. The access controller 105 broadcasts (e.g., the controller manager 205 instructs the wireless transceiver 210 to broadcast) a beacon frame to inform all co-operating wireless devices 110 in the locality that a new spectrum access controller 105 has come online.
2. The co-operating wireless devices 110 that receive the beacon frame perform spectrum sensing in their respective frequency bands of interest.
3. The co-operating wireless devices 110 transmit their respective spectrum sensing information along with their respective device requirements and capabilities 335 such as supported frequency bands, bandwidth and data rate to the spectrum access controller 105.
4. Based on the collected information from the co-operating wireless devices 110, the spectrum access controller 105 optimizes the spectrum allocation and resolves any spectrum usage inefficiencies among the co-operating wireless devices 110. A new spectrum usage map 220 is created.
5. The spectrum access controller 105 sends the operating frequency band parameters derived from the new spectrum usage map to the co-operating wireless devices 110.
6. The co-operating wireless devices 110 then operate their transceivers 315 using the assigned parameters (e.g., channel(s) selection information, transceiver operating parameters, etc.).
   New Locality of Co-operating Wireless Device 110

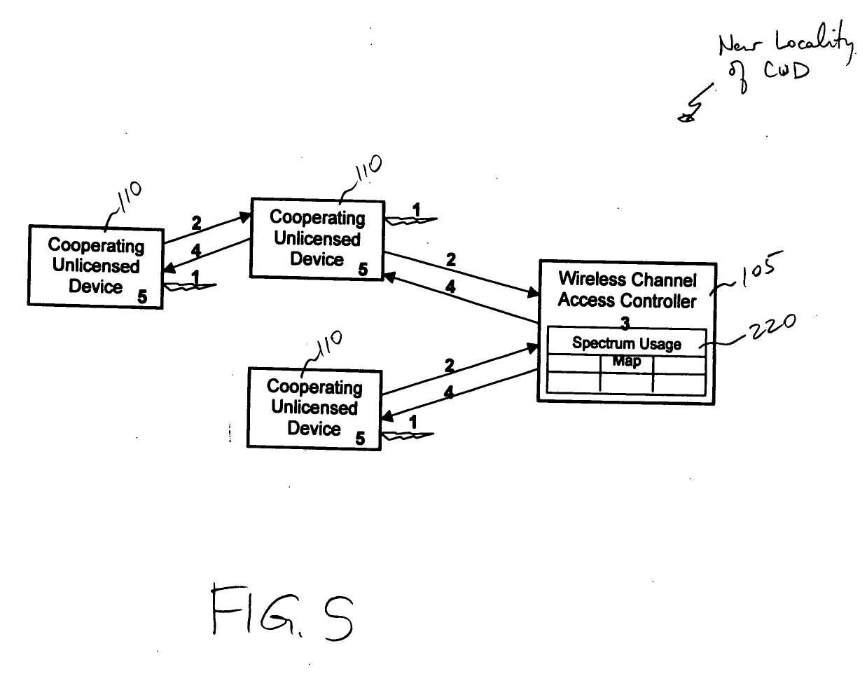

A co-operating wireless device 100 is considered to be new in a locality if the spectrum access controller 105 in that locality does not have the spectrum usage information of the co-operating wireless device 110 in its spectrum usage map. As shown in FIG. 5, when a new co-operating wireless device 110 operates for the first time in a locality:
1. The co-operating wireless device 110 first performs spectrum sensing in the relevant frequency band(s).
2. The co-operating wireless device 110 transmits a request frame containing the spectrum sensing information along with its device requirements and capabilities.
3. The spectrum access controller 105 may receive the request frame directly from the new co-operating wireless device 110 or conveyed from other co-operating wireless devices 110 in a multi-hop manner.
4. The spectrum access controller 105 updates its spectrum usage map 220 based on the spectrum sensing information from the new co-operating wireless device 110. Based on the requested resources and the spectrum sensing information from the new co-operating wireless device 100, the spectrum access controller 105 allocates resources according to its updated spectrum usage map 220 (which indicates spectrum use of neighboring devices 110, available channels, channel characteristics, etc.).
5. The spectrum access controller 105 sends the operating frequency band parameters derived from the updated spectrum usage map 220 to the new co-operating wireless device 110.
6. The new co-operating wireless device 110 uses the assigned parameters to start its operations.
7. If the spectrum access controller 105 deems that no spectrum resource is sufficient to support the new co-operating wireless device 110, then it will not accommodate the new device 110. In that case, the co-operating wireless device 110 can either back down and try at a later time to respect the co-existence, or it could act autonomously as a legacy wireless device 115 and proceed to operate.
8. If the new co-operating wireless device 110 fails to receive a spectrum access controller 105 reply after a certain number of attempts of transmitting the request frame, possibly over a predetermined set of dedicated channels 215, the new co-operating wireless device 110 assumes that the locality is not under any spectrum access controller 105 control, and hence proceeds to operate in an autonomous mode. Meanwhile, it will continue to listen for a spectrum access controller 105 beacon in case one comes online.
   Normal Operation

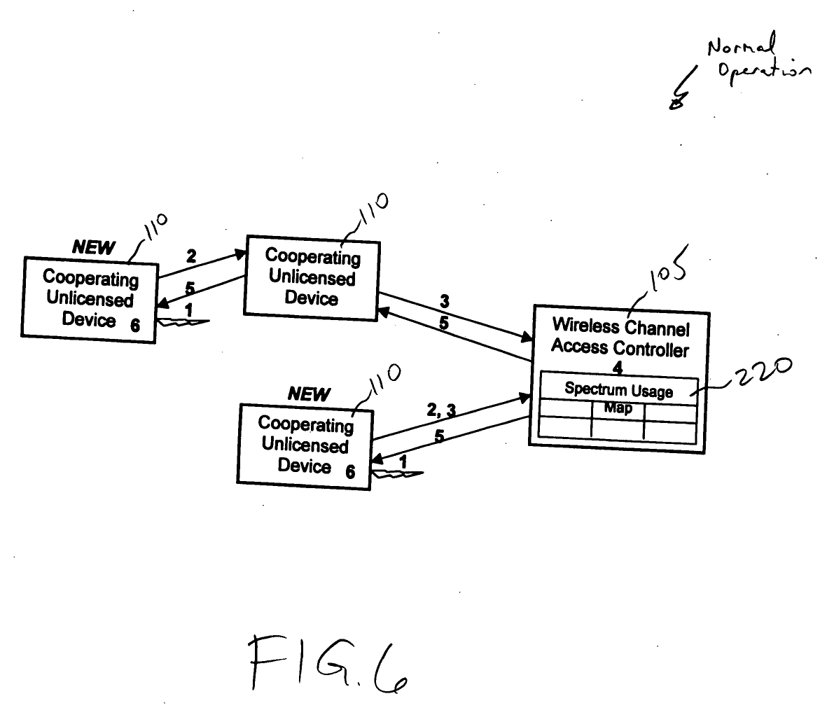

As shown in FIG. 6, during normal operation:
1. The co-operating wireless device 110 performs spectrum sensing on a fixed interval. For each co-operating wireless device 110, the interval size may be set depending on a power consumption requirement. For portable devices, interval size can be larger to save power. Alternatively, the access controller 105 may set the interval to be used by each co-operating wireless device 110 (either on a per device 110 basis such that each may or may not have the same interval, or on a collective basis where all devices 110 receive the same interval requirement).
2. The co-operating wireless devices 110 transmit the information from each spectrum sensing session along with their current device requirements and capabilities 335, e.g., transceiver operating information, to the spectrum access controller 105.
3. For each spectrum sensing interval, the spectrum access controller 105 reallocates spectrum usage if necessary and updates its spectrum usage map 220 accordingly.
4. The spectrum access controller 105 sends the parameters derived from the spectrum usage map 220 to the co-operating wireless devices 110.
5. The co-operating wireless devices 110 start or continue operating using the updated or unchanged parameters.
   Legacy Device Interference

A legacy wireless device 115 (whether being added or preexisting) operating within a locality may affect the performance of one or more co-operating wireless devices 110. This situation can be rectified during normal operation when the co-operating wireless devices 110 perform regular spectrum sensing. But, if the affected co-operating wireless devices 110 cannot wait until the regular spectrum sensing time due to critical operation, the co-operating wireless device 110 can perform the following:
1. The affected co-operating wireless device 110 initiates a spectrum sensing session.
2. The spectrum sensing information and device requirements and capabilities are transmitted to the spectrum access controller 105.
3. The spectrum access controller 105 reallocates spectrum usage, updates its spectrum usage map 220 accordingly, and sends the transceiver operating parameters to the affected co-operating wireless device 110. In either case, if spectrum resources do not permit efficient reallocation, the spectrum access controller 105 may keep the original state of the spectrum usage map 220.
4. The co-operating wireless device 110 updates its transceiver operating parameters accordingly.
5. The co-operating wireless device 110 starts its operations using the updated transceiver operating parameters.
   Co-operating Wireless Device Leaves a Locality

A co-operating wireless device 110 is considered to have left a locality controlled by a spectrum access controller 105 if it has been physically moved to a new location beyond the reach of the spectrum access controller 105 or has powered off. In either case, the spectrum access controller 105 stops receiving spectrum sensing and transceiver information update frames from the co-operating wireless device 110. After a certain period, the access controller 105 may remove the co-operating wireless device 110 information from the spectrum usage map 220.

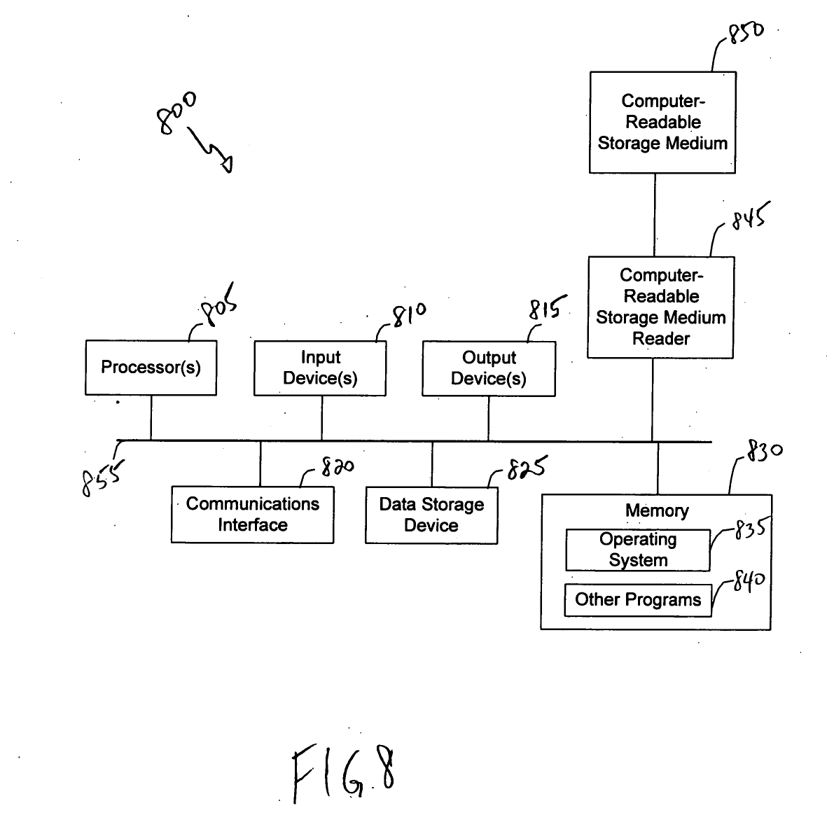

FIG. 8 is a block diagram illustrating details of an example computer system 800, of which each co-operating wireless device 110 and access controller 105 may be an instance. Computer system 800 includes a processor 805, such as an Intel Pentium® microprocessor or a Motorola Power PC® microprocessor, coupled to a communications channel 855. The computer system 800 further includes an input device 810 such as a keyboard or mouse, an output device 815 such as a cathode ray tube display, a communications device 820, a data storage device 825 such as a magnetic disk, and memory 830 such as Random-Access Memory (RAM), each coupled to the communications channel 855. The communications interface 820 may be coupled to a network such as the wide-area network commonly referred to as the Internet. One skilled in the art will recognize that, although the data storage device 825 and memory 830 are illustrated as different units, the data storage device 825 and memory 830 can be parts of the same unit, distributed units, virtual memory, etc.

The data storage device 825 and/or memory 830 may store an operating system 835 such as the Microsoft Windows NT or Windows/95 Operating System (OS), the IBM OS/2 operating system, the MAC OS, or UNIX operating system and/or other programs 840. It will be appreciated that a preferred embodiment may also be implemented on platforms and operating systems other than those mentioned. An embodiment may be written using JAVA, C, and/or C++language, or other programming languages, possibly using object-oriented programming methodology.

One skilled in the art will recognize that the computer system 800 may also include additional information, such as network connections, additional memory, additional processors, LANs, input/output lines for transferring information across a hardware channel, the Internet or an intranet, etc. One skilled in the art will also recognize that the programs and data may be received by and stored in the system in alternative ways. For example, a computer-readable storage medium (CRSM) reader 845 such as a magnetic disk drive, hard disk drive, magneto-optical reader, CPU, etc. may be coupled to the communications bus 855 for reading a computer-readable storage medium (CRSM) 850 such as a magnetic disk, a hard disk, a magneto-optical disk, RAM, etc. Accordingly, the computer system 800 may receive programs and/or data via the CRSM reader 845. Further, it will be appreciated that the term “memory” herein is intended to cover all data storage media whether permanent or temporary.

Embodiments of the invention are most applicable in places where there is high density usage of wireless devices 110 such as in homes and wireless hotspots. In multi-tenant residential buildings, this network system 100 can provide some form of frequency planning to ensure that adjacent tenants do not encounter severe spectrum overlap, while tenants who are spaced further apart are allowed to reuse same spectrum bands. In the near future, as an enterprise adopts more wireless technologies in their IT infrastructure, embodiments of this invention can be used to regulate wireless spectrum usage within large office premises.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A system for managing spectrum usage of co-operating wireless devices, comprising:
a plurality of co-operating wireless devices, each co-operating wireless device capable of sensing spectrum usage where the co-operating wireless device operates and of generating spectrum usage information; and
a spectrum access controller communicatively coupled to each of the co-operating wireless devices, the spectrum access controller capable of receiving the spectrum usage information from each of the co-operating wireless devices and for managing spectrum allocation to the co-operating wireless devices based on the spectrum usage information.

2. The system of claim 1, wherein the spectrum access controller is coupled to at least one co-operating wireless device using a multi-hop protocol.

3. The system of claim 1, wherein the access controller requests at least two co-operating wireless devices to operate using the same channel.

4. The system of claim 1, further comprising a legacy wireless device operating near at least one co-operating wireless device, wherein the co-operating wireless device senses the spectrum usage of the legacy wireless device, and wherein the spectrum usage information identifies the spectrum use of the legacy wireless device.

5. The system of claim 1, wherein at least one co-operating wireless device conducts spectrum sensing at a regular interval.

6. The system of claim 1, wherein at least one co-operating wireless device is capable of receiving parameters from the access controller, the parameters defining a spectrum channel over which to communicate when performing the function of the co-operating wireless device.

7. The system of claim 1, wherein at least one co-operating wireless device is configured to send device information to the access controller, the device information for use by the access controller to manage spectrum allocation.

8. A method of controlling spectrum usage of wireless device, comprising:
sensing spectrum usage where a wireless device operates;
generating spectrum usage information based on the sensing;
transmitting the spectrum usage information to an access controller;
awaiting from the access controller spectrum allocation parameters based on the spectrum usage information; and
configuring a transceiver in the wireless device based on the spectrum allocation parameters from the access controller.

9. The method of claim 8, wherein the step of sensing includes sensing interference by a legacy device operating near the wireless device, and wherein the spectrum usage information identifies the spectrum use of the legacy device.

10. The method of claim 8, wherein the wireless device conducts spectrum sensing at a regular interval.

11. The method of claim 8, further comprising sending device information by the wireless device to the access controller, the device information for use by the access controller to manage spectrum allocation.

12. A method of managing spectrum usage of a wireless device, comprising:
receiving spectrum usage information specifying spectrum usage where wireless devices operate;
generating spectrum allocation parameters for each of the wireless devices based on the spectrum usage information; and
sending spectrum allocation parameters to the wireless devices.

14. The method of claim 12, wherein the step of generating spectrum allocation parameters includes generating spectrum allocation parameters for configuring at least two co-operating wireless devices to operate using the same channel.

15. The method of claim 12, wherein the spectrum allocation parameters account for the spectrum use of legacy wireless devices.

16. The method of claim 12, wherein the method occurs at a regular interval.

17. The method of claim 12, further comprising receiving device information from the wireless device, the device information for use by the access controller in the step of generating spectrum allocation parameters.
